(19) United States
(12) Patent Application Publication
(10) Pub. No.: US 2018/0039779 A1
(43) Pub. Date: Feb. 8, 2018

(54) Predictive Behavioral Analysis for Malware Detection

(71) Applicant: QUALCOMM Incorporated, San Diego, CA (US)

(72) Inventors: Dong Li, Cupertino, CA (US); Yin Chen, Campbell, CA (US); Saumitra Mohan Das, San Jose, CA (US)

(21) Appl. No.: 15/228,251

(22) Filed: Aug. 4, 2016

(51) Int. Cl. G06F 21/56

(52) U.S. Cl. CPC G06F 21/566; G06F 21/562; G06F 2221/033

(57) ABSTRACT

A computing device may be protected from non-benign behavior, malware, and cyber attacks by using a combination of predictive and real-time behavior-based analysis techniques. A computing device may be configured to identify anticipated behaviors of a software application before runtime, analyze the anticipated behaviors before runtime to generate static analysis results, commencing execution of the software application, analyze behaviors of the software application during runtime via a behavior-based analysis system, and control operations of the behavior-based analysis system based on the static analysis results.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are becoming the next frontier for malware and cyber attacks. Accordingly, new and improved security solutions that better protect resource-constrained computing devices, such as mobile and wireless devices, will be beneficial to consumers.

### SUMMARY

Various embodiments include methods that may be implemented by a processor of a computing device for using a combination of predictive and behavior-based analysis to protect the mobile computing device from malware and non-benign behaviors. Various embodiments may include identifying before runtime anticipated behaviors of a software application, and analyzing before runtime the anticipated behaviors to generate static analysis results. Various embodiments may further include commencing execution of the software application, analyzing activities of the software application during runtime via a behavior-based analysis system executing in the processor to generate dynamic analysis results, and controlling operations of the behavior-based analysis system based on the static analysis results.

In some embodiments, analyzing before runtime the anticipated behaviors to generate the static analysis results may include classifying one or more of the anticipated behaviors as benign. In such embodiments, controlling operations of the behavior-based analysis system based on the static analysis results may include forgoing analysis of an activity that corresponds to an anticipated behavior classified as benign.

In some embodiments, analyzing the anticipated behaviors to generate the static analysis results may include classifying one or more of the anticipated behaviors as suspicious. In such embodiments, controlling operations of the behavior-based analysis system based on the static analysis results may include selecting for analysis by the behavior-based analysis system an activity that corresponds to an anticipated behavior classified as suspicious.

In some embodiments, analyzing the anticipated behaviors to generate the static analysis results may include generating a first behavior vector that includes static behavior information. In such embodiments, analyzing the activities of the software application during runtime via the behavior-based analysis system may include generating a second behavior vector that includes dynamic behavior information. Also in such embodiments, controlling operations of the behavior-based analysis system based on the static analysis results may include combining the first behavior vector and the second behavior vector to generate a third behavior vector that includes both static behavior information and dynamic behavior information.

Some embodiments may further include classifying, before runtime, at least one of the anticipated behaviors based on the static analysis results to generate a static analysis behavior classification, and computing a first confidence value that identifies a probability that the static analysis behavior classification of the at least one anticipated behavior is accurate. Such embodiments may further include classifying a corresponding behavior of the software application during runtime based on the dynamic analysis results to generate a dynamic analysis behavior classification, and computing a second confidence value that identifies the probability that the dynamic analysis behavior classification of the corresponding behavior is accurate. Such embodiments may further include determining whether the first confidence value exceeds the second confidence value, using the static analysis behavior classification in response to determining that the first confidence value exceeds the second confidence value, and using the dynamic analysis behavior classification in response to determining that the first confidence value does not exceed the second confidence value.

Some embodiments may further include determining probability values that each identifies a likelihood of that one of the anticipated behaviors will be non-benign, and prioritizing the anticipated behaviors based on the probability values. In such embodiments, controlling operations of the behavior-based analysis system based on the static analysis results may include causing the behavior-based analysis system to evaluate the one or more behaviors of the software application based on the probability values.

Some embodiments may further include determining a number of the activities that could be evaluated at runtime without having a significant negative impact on a performance characteristic or a power consumption characteristic of the mobile computing device. In such embodiments, controlling operations of the behavior-based analysis system based on the static analysis results may include causing the behavior-based analysis system to evaluate only the determined number of the activities at runtime.

In some embodiments, analyzing, before runtime, the anticipated behaviors to generate the static analysis results may include analyzing the anticipated behaviors in layers prior to runtime. In some embodiments, analyzing the anticipated behaviors in layers prior to runtime may include analyzing the anticipated behaviors at a first level to generate first results and a first confidence value, determining whether the first confidence value exceeds a threshold value, and analyzing the anticipated behaviors at a second level to generate second results and a second confidence value in response to determining that the first confidence value does not exceed the threshold value.

Further embodiments include a mobile computing device that includes a processor that is configured with processor-executable instructions to perform operations of the embodiment methods summarized above. Further embodiments include a non-transitory computer readable storage medium having stored thereon processor-executable software instructions configured to cause a processor of a mobile computing device to perform operations of the embodiment methods summarized above. Further embodiments include a mobile computing device that includes means for performing functions of the embodiment methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram illustrating components of an example system on chip that may be included in a computing device and configured to use predictive and real-time behavioral analysis to identify, prevent or otherwise respond to existing and potential non-benign device behaviors in accordance with various embodiments.

FIG. 2A is a block diagram illustrating example logical components and information flows in a layered predictive analysis system (LPA system) configured in accordance with various embodiments.

FIG. 2B is a block diagram illustrating example logical components and information flows in a runtime behavioral monitoring and analysis system (BMA system) configured in accordance with various embodiments.

FIG. 3 is a process flow diagram illustrating a predictive analysis method for analyzing anticipated behaviors in layers in accordance with an embodiment.

FIG. 4 is a block diagram illustrating example layers of a layered predictive analysis system that could be configured to identify, prevent or otherwise respond to anticipated behaviors in accordance with various embodiments.

FIGS. 5 through 8 are process flow diagrams illustrating methods of using a combination of predictive and real-time behavioral analysis to protect a computing device from malware and other non-benign behaviors in accordance with various embodiments.

FIG. 9 is a component block diagram of a mobile computing device that is suitable for use with various embodiments.

FIG. 10 is a component block diagram of a server device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, various embodiments include methods, and computing devices (e.g., mobile or other resource-constrained computing devices, etc.) configured to implement the methods, for efficiently identifying, predicting and responding to non-benign applications (e.g., malware, etc.) or device behaviors that could have a negative impact on the performance and/or power consumption characteristic of the computing device over time.

In the various embodiments, a computing device may be equipped with a layered predictive analysis (LPA) system and a runtime behavioral monitoring and analysis (BMA) system. The LPA system may be configured to work in conjunction with the runtime BMA system to better identify, detect, classify, model, prevent and/or correct conditions and behaviors that could degrade the computing device's performance and/or power utilization levels over time. The LPA system may be configured to use static, emulation and/or prediction techniques, or the results of static, emulation and/or prediction techniques, to evaluate an anticipated behavior of the mobile device executing a dormant or not active application in advance of runtime. The results of the static analysis of the application may be stored in memory for use by the BMA system during runtime. The runtime BMA system may be configured to use real-time behavior-based and machine learning techniques to evaluate device behaviors at runtime leveraging information obtained from the LPA system.

In some embodiments, the computing device may be configured to use analysis results generated by the layered predictive analysis system (LPA system) to intelligently filter or select the software applications or behaviors that are to be monitored or evaluated by the runtime behavioral monitoring and analysis system (BMA system), or to otherwise control the operations of the BMA system. For example, the computing device may first use the LPA system to identify, predict, or anticipate a large number of behaviors that the software application could exhibit during runtime. The computing device may use the LPA system to evaluate/analyze a large number of the anticipated device behaviors via static analysis techniques, identify the anticipated behaviors that may be classified as benign or non-benign with a high degree of confidence in advance of runtime, mark any or all of these identified behaviors as not requiring further analysis, and/or mark the remaining behaviors as suspicious behaviors that require further analysis (e.g., at runtime). In some embodiments, the LPA system may be further configured to determine the probability of each anticipated behavior causing problems on the device, determine the importance or criticality of the anticipated behaviors, and prioritize the anticipated behaviors for monitoring by the BMA system accordingly.

At runtime, the computing device may control or focus the operations of the BMA system based on the results of analyses by the LPA system. For example, the computing device may cause the BMA system to forgo analyzing selected behaviors that are marked as not requiring further analysis (e.g., benign behaviors, etc.) based on the results of analyses by the LPA system. As another example, the computing device could cause the BMA system to analyze only the behaviors that are marked as suspicious by the LPA system. The computing device may determine the number of behaviors that could be evaluated at runtime without having a significant or negative impact on the performance or power consumption characteristics of the device, and cause the BMA system to evaluate only the determined number of behaviors and/or in accordance with their determined priorities.

In some embodiments, the computing device may be configured to use the analysis results generated by the layered predictive analysis system (LPA system) to augment or strengthen the analysis results generated by the runtime behavioral monitoring and analysis system (BMA system). For example before runtime the computing device may use the LPA system to generate a first lightweight behavior vector that characterizes an anticipated behavior (or an inactive software application, etc.). The generated first lightweight behavior vector may be stored in memory for use at runtime. During runtime, the computing device may use the BMA system to generate a second lightweight behavior vector that characterizes a corresponding behavior (or the inactive software application after it becomes active). The computing device may then combine (e.g., add, concatenate, merge, etc.) the first and second lightweight behavior vectors to generate a more robust behavior vector that includes both static and dynamic information and/or which better characterizes the behavior. The computing device may then apply the generated more robust behavior vector to a stronger or more robust classifier model to generate more accurate analysis results. A stronger or more robust classifier model may include decision nodes that evaluate a combination of static and dynamic device features. The computing device may use the results of applying the more robust classifier model to the more robust classifier model to generated more robust behavior vector to achieve better or more accurately classification of the behavior or software application (e.g., more conclusively, with a higher degree of confidence, etc.).

In some embodiments, the computing device may be configured to use the analysis results generated by the layered predictive analysis system (LPA system) in lieu of the analysis results generated by the runtime behavioral monitoring and analysis system (BMA system), or vice versa. For example, the computing device may be configured to use the LPA system to evaluate a behavior and generate a first analysis result (e.g., static analysis results, etc.) having a first confidence value (or “Static Malicious Score”). The computing device may use the BMA system to evaluate the same or corresponding behavior at runtime, and generate a second analysis result (e.g., dynamic analysis results) having a second confidence value (or “Dynamic Malicious Score”). The computing device may compare the first and second confidence values, select the analysis result associated with the higher confidence value, and use the selected analysis result to classify the behavior or software application as benign or non-benign.

The various embodiments improve the functioning of a computing device by improving its security, performance, and power consumption characteristics. For example, by using the results generated by the LPA system to intelligently filter or select the applications or behaviors that are monitored or evaluated by the BMA system, the various embodiments allow the computing device to forgo performing spurious operations and focus runtime analysis operations on the behaviors that are most likely to degrade the device's performance and power consumption over time. In addition, by analyzing application software to identify API's that will be called, data sources that will be accessed and communications (e.g., exporting data) of actions (e.g., encrypting or deleting files) that have the potential for abuse by malware, as well as identifying Application Programming Interface (API) calls and operations that are most likely to be benign, the LPA system is able to predict behaviors that should be observed by the runtime BMA system. This pre-selection of behaviors to be observed reduces overhead of the real-time dynamic analysis operations and eliminates (filters out) observations of behaviors most likely to be benign. Also, by identifying APIs, operations, and data access that have a high probability of being associated with non-benign activity (essentially identifying behaviors to watch), the computing device is able to more rapidly identify malware and non-benign behaviors via monitoring by the BMA system. Further, using the BMA system in accordance with the various embodiments reduces the incidences of false positives and false negatives. Additional improvements to the functions, functionalities, and/or functioning of computing devices will be evident from the detailed descriptions of the embodiments provided below.

Phrases such as “performance degradation,” “degradation in performance” and the like may be used in this application to refer to a wide variety of undesirable operations and characteristics of a network or computing device, such as longer processing times, slower real time responsiveness, lower battery life, loss of private data, malicious economic activity (e.g., sending unauthorized premium short message service (SMS) message), denial of service (DoS), poorly written or designed software applications, malicious software, malware, viruses, fragmented memory, operations relating to commandeering the device or utilizing the device for spying or botnet activities, etc. Also, behaviors, activities, and conditions that degrade performance for any of these reasons are referred to herein as “not benign” or “non-benign.”

The terms “wireless device,” “mobile device,” and “mobile computing device” are used generically and interchangeably herein and may refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar electronic devices which include a memory, a programmable processor for which performance is important, and operate under battery power such that power conservation methods are of benefit. While the various embodiments are particularly useful for mobile and resource-constrained systems, the embodiments are generally useful in any computing device that includes a processor and executes software applications.

The term “runtime system” is used in this application to refer to a combination of software and/or hardware resources in a computing device that support the execution of an application program in that device. For example, a runtime system may include all or portions of the computing device's processing resources, operating systems, library modules, schedulers, processes, threads, stacks, counters, and/or other similar components. A runtime system may be responsible for allocating computational resources to an application program, for controlling the allocated resources, and for performing the operations of the application program. The runtime system may execute or perform all or portions of a software application in one or more hardware processing units (e.g., processor, a processing core, etc.) via processes, threads, or tasks.

Generally, the performance, power efficiency, and security of a mobile device degrade over time. Recently, anti-virus companies (e.g., McAfee, Symantec, etc.) have begun marketing mobile anti-virus, firewall, and encryption products that aim to slow this degradation. However, many of these solutions rely on the periodic execution of a computationally-intensive scanning engine on the mobile device, which may consume many of the mobile device's processing and battery resources, slow or render the mobile device useless for extended periods of time, and/or otherwise degrade the user experience. In addition, these solutions are typically limited to detecting known viruses and malware, and do not address the multiple complex factors and/or the interactions that often combine to contribute to a mobile device's degradation over time (e.g., when the performance degradation is not caused by viruses or malware). For these and other reasons, existing anti-virus, firewall, and encryption products do not provide adequate solutions for identifying the numerous factors that may contribute to a mobile device's degradation over time, for preventing mobile device degradation, or for efficiently restoring an aging mobile device to its original condition.

There are a large variety of factors that may contribute to the degradation in performance and power utilization levels of a mobile device over time, including poorly written or designed software applications, malware, viruses, fragmented memory, background processes, etc. Due to the number, variety, and complexity of these factors, it is often not feasible to evaluate all of the factors that may contribute to the degradation in performance and/or power utilization levels of the complex yet resource-constrained systems of modern mobile computing devices. As such, it is difficult for users, operating systems, and/or application programs (e.g., anti-virus software, etc.) to accurately and efficiently identify the sources of such problems. As a result, mobile device users have few remedies for preventing the degradation in performance and power utilization levels of a mobile device over time, or for restoring an aging mobile device to its original performance and power utilization levels.

To provide better performance in view of these facts, a mobile device may be equipped with a runtime behavioral monitoring and analysis system (BMA system) that is configured to quickly determine whether a particular mobile device behavior, condition, sub-system, software application, or process is benign or not benign without these operations consuming an excessive amount of the devices processing, memory, or energy resources. The BMA system may include an observer process, daemon, module, or sub-system (herein collectively referred to as a “module” or “component”), a behavior extractor component, and an analyzer component.

The observer component may be configured to instrument or coordinate various application programming interfaces (APIs), registers, counters or other components (herein collectively “instrumented components”) at various levels of the computing device system. The observer component may continuously (or near continuously) monitor activities of the computing device by collecting behavior information from the instrumented components (which may be accomplished by reading information from API log files stored in a memory of the computing device), and send the collected behavior information to the behavior extractor component (e.g., via a memory write operation, function call, etc.).

The behavior extractor component may use the collected behavior information to generate behavior vectors that each represent or characterize many or all of the observed behaviors that are associated with a specific software application, module, component, sub-system, task, or process of the mobile device. The behavior extractor component may communicate (e.g., via a memory write operation, function call, etc.) the generated behavior vectors to the analyzer component.

The analyzer component may apply the behavior vectors to classifier models to generate analysis results, and use the analysis result to determine whether a software application or device behavior may be classified as benign or non-benign (e.g., malicious, poorly written, performance-degrading, etc.).

While the above described runtime behavioral monitoring and analysis system (BMA system) is generally effective for classifying active software applications, is not adequate for use in determining whether an inactive/dormant software application is non-benign, or for identifying threats (e.g., potentially non-benign applications or behaviors, etc.) in advance of runtime or program execution. This is because the BMA system uses behavior information that is collected at runtime (while the software application executes). In addition, due to the large number and variety of factors in the computing device that could require analysis, it is often challenging to operate the BMA system continuously (or near continuously) without its operations having a negative or user-perceivable impact on the computing device's performance or power consumption characteristics.

The various embodiments equip a computing device (mobile computing device, etc.) with a layered predictive analysis system (LPA system) that is configured to work in conjunction with a runtime behavioral monitoring and analysis system (BMA system) of the computing device. The various embodiments allow the computing device to better and more efficiently identify, detect, classify, model, prevent, and/or correct conditions and behaviors that could degrade the device's performance and/or power utilization levels over time. The combination of the LPA system and the BMA system according to the embodiments enable these operations to be accomplished without having a significant negative or user-perceivable impact on the responsiveness, performance, or power consumption characteristics of the device. By using predictive behavioral analysis techniques, the various embodiments allow the computing device to detect potential threats and non-benign behaviors before the behaviors occur.

In various embodiments, the layered predictive analysis system (LPA system) may be configured to collect or receive information (e.g., metadata, object code, etc.) from various levels of the computing device, and use static analysis, heuristics, speculation, behavior-based analysis and/or machine learning techniques to determine (i.e., infer, estimate, speculate or predict) the behaviors of the software application or device. As part of these operations, the LPA system may analyze metadata (a manifest file, etc.), resource estimates, code complexity, key sensitive APIs, reachability, distances on call-graphs, data dependence, memory dependence, inter-method relationships and interactions, and other similar information, structures, conditions or events. In addition, the LPA system may count the number of lines of code, count the number of sensitive/interesting API calls, examine the corresponding source code, call methods to unroll source code or operations/activities, examine the resulting source code, recursively count the number of lines of code, recursively count the number of sensitive/interesting API calls, determine the total number of lines of code reachable from an activity, determine the total number of sensitive/interesting API calls reachable from an activity, generate an activity transition graph, determine how the different activities (i.e., graphical user interface screens) are linked to one another, etc.

In some embodiments, the layered predictive analysis (LPA) system may be configured to simulate or emulate the behaviors (i.e., inferred, estimated, speculated, predicted or anticipated behaviors) to collect information on anticipated behaviors. The LPA system may use the collected anticipated behavior information to generate behavior vectors, and apply the generated behavior vectors to classifier models to generate static/predictive analysis results. The LPA system may use the generated analysis results to determine whether the behavior can be classified as benign or non-benign with a sufficiently high degree of confidence. The LPA system may classify the behavior as one of benign and non-benign in response to determining that the behavior may be classified as benign or non-benign with a sufficiently high degree of confidence, and/or mark the behavior as suspicious in response to determining that the behavior may not be classified as benign or non-benign with a sufficiently high degree of confidence.

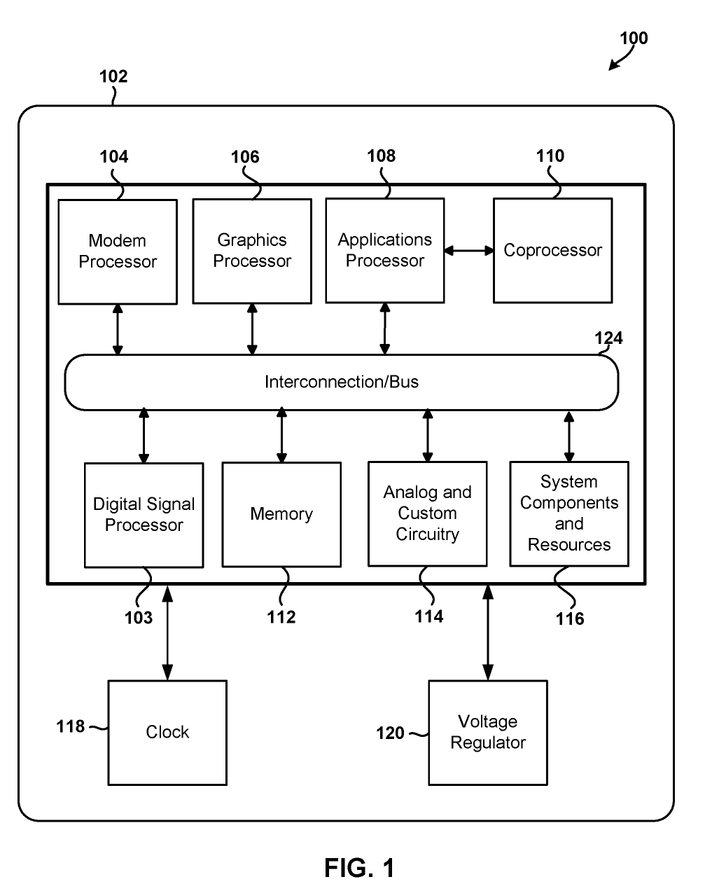

The various embodiments may be implemented on a number of single processor and multiprocessor computer systems, including a system-on-chip (SOC). FIG. 1 illustrates an example system-on-chip (SOC) 100 architecture that may be used in computing devices implementing the various embodiments. The SOC 100 may include a number of heterogeneous processors, such as a digital signal processor (DSP) 103, a modem processor 104, a graphics processor 106, and an applications processor 108. The SOC 100 may also include one or more coprocessors 110 (e.g., vector co-processor) connected to one or more of the heterogeneous processors 103, 104, 106, 108. Each processor 103, 104, 106, 108, 110 may include one or more cores, and each processor/core may perform operations independent of the other processors/cores. For example, the SOC 100 may include a processor that executes a first type of operating system (e.g., FreeBSD, LINUX, OS X, etc.) and a processor that executes a second type of operating system (e.g., Microsoft Windows 8).

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software clients (e.g., a web browser) running on a computing device.

The system components and resources 116 and/or analog and custom circuitry 114 may include circuitry to interface with peripheral devices, such as cameras, electronic displays, wireless communication devices, external memory chips, etc. The processors 103, 104, 106, 108 may be interconnected to one or more memory elements 112, system components and resources 116, and analog and custom circuitry 114 via an interconnection/bus component 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output component (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 103, a modem processor 104, a graphics processor 106, an applications processor 108, etc.).

In an embodiment, the SOC 100 may be included in a mobile computing device 102, such as a smartphone. The mobile computing device 102 may include communication links for communication with a telephone network, the Internet, and/or a network server. Communication between the mobile computing device 102 and the network server may be achieved through the telephone network, the Internet, private network, or any combination thereof.

In various embodiments, the SOC 100 may be configured to collect behavioral, state, classification, modeling, success rate, and/or statistical information in the mobile device, and send the collected information to the network server (e.g., via the telephone network) for analysis. The network server may use information received from the mobile device to generate, update or refine classifiers or data/behavior models that are suitable for use by the SOC 100 when identifying and/or classifying performance-degrading mobile device behaviors. The network server may send data/behavior models to the SOC 100, which may receive and use data/behavior models to identify suspicious or performance-degrading mobile device behaviors, software applications, processes, etc.

The SOC 100 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, global positioning system (GPS) receivers, communications circuitry (e.g., Bluetooth®, WLAN, WiFi, etc.), and other well-known components (e.g., accelerometer, etc.) of modern electronic devices.

In addition to the mobile computing device 102 and SOC 100 discussed above, the various embodiments may be implemented in a wide variety of computing systems, which may include a single processor, multiple processors, multicore processors, or any combination thereof.

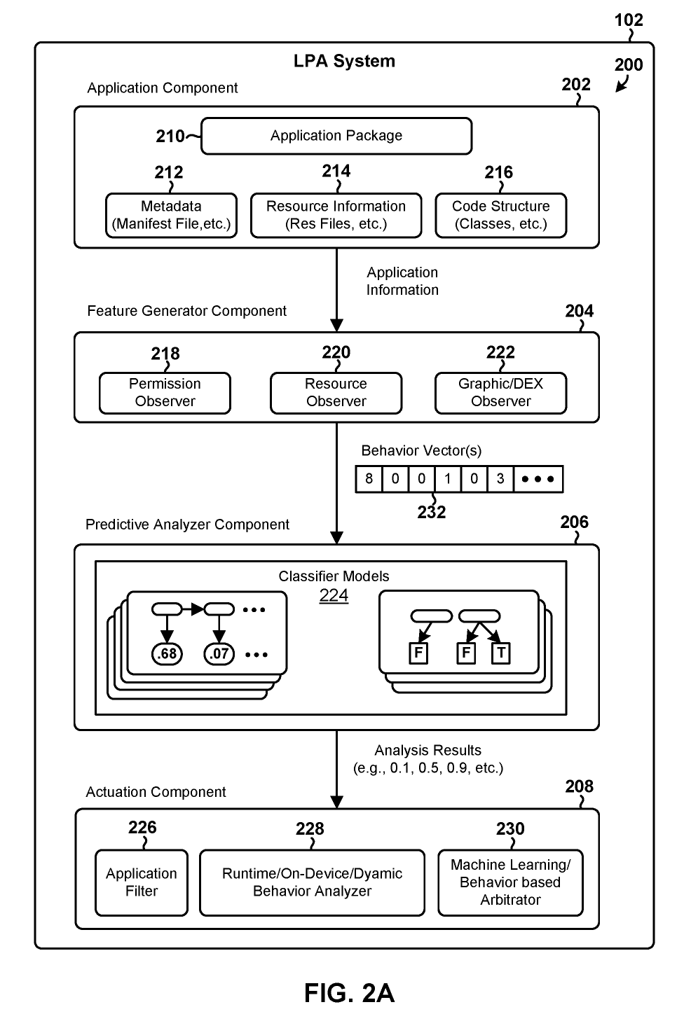

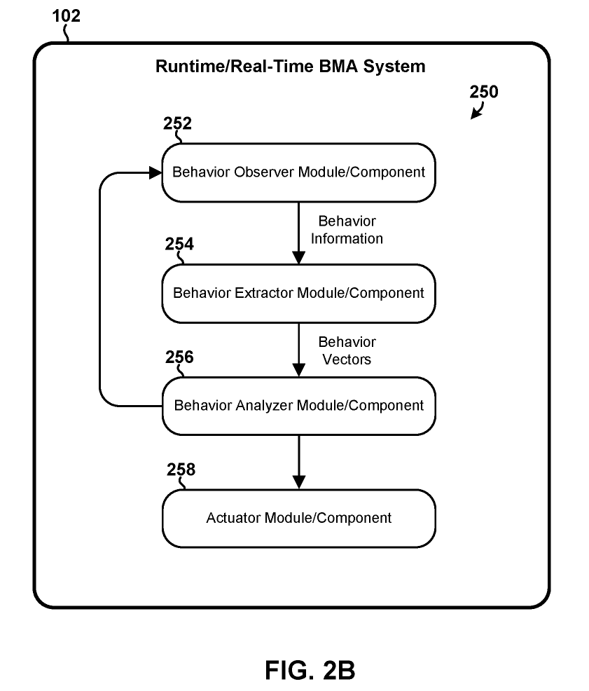

FIG. 2A illustrates a layered predictive analysis system (LPA system) 200 that is configured to use static analysis, dynamic analysis, heuristics, speculation, behavior-based analysis and/or machine learning techniques to evaluate device behaviors and software applications in accordance with the various embodiments. In the example illustrated in FIG. 2A, the LPA system 200 includes an application component 202, a feature generator component 204, a predictive analyzer component 206, and an actuation component 208. Each of these components 202-208 may be a thread, process, daemon, module, sub-system, or component that is implemented in software, firmware, hardware, or a combination thereof. In various embodiments, the components 202-208 may be implemented within parts of the operating system (e.g., within the kernel, in the kernel space, in the user space, etc.), within separate programs or applications, in specialized hardware buffers or processors, or any combination thereof. In some embodiments, one or more of the components 202-208 may be implemented as software instructions executing on one or more processors of a mobile computing device 102.

The application component 202 may include an application package 210 component, a metadata 212 component, a resource information 214 component, a code structure 216 component, and other similar information, structures or units. In an embodiment, application package 210 may include the metadata 212, resource information 214, and code structure 216 components.

The application package 210 component may include all of the resources and information associated with a software application. For example, the application package 210 may include a software application's program code, bytecode, resources, assets, certificates, metadata, etc. In an embodiment, the application package 210 component may include an Android® application package (APK) file, an Application eXcellence (APPX) file, or other similar software packages or software package information. The metadata 212 component may include a manifest file or other similar information structures. The resource information 214 component may include one or more Res files and/or other similar information or information structures. The code structure 216 component may include stored procedures, classes, functions, objects, and other information or structures that may be used to perform static analysis operations and/or to characterize the behavior the software application.

The feature generator component 204 may include a permission observer 218 component, a resource observer 220 component, and a graphic or Direct Exchange (DEX) observer 222 component. Any or all of the permission observer 218, resource observer 220 and DEX observer 222 components may be configured to monitor and collect any or all of the information described further below with reference to the behavior observer component 252 illustrated in FIG. 2B.

The feature generator component 204 may be configured to use (e.g., via a processor in the mobile computing device 102, etc.) a feature definition language to define activities or behaviors that are to be monitored by the permission observer 218, resource observer 220 and/or DEX observer 222. The feature generator component 204 may be configured to emulate normal behaviors of the mobile computing device 102 to identify anticipated behaviors of the software application. The feature generator component 204 may be configured to perform static analysis operations to evaluate the anticipated behaviors of the software application. The feature generator component 204 may be configured to collect and use behavior information to generate emulation and/or analysis results. The feature generator component 204 may be configured to use the emulation and/or analysis results (e.g., results generated from performing the static analysis operations, etc.) to generate behavior vectors 232 that each succinctly describe or characterize a range of correct or expected behaviors of the software application program. The feature generator component 204 may be configured to send the generated behavior vectors to the predictive analyzer component 206.

Each behavior vector 232 may be an information structure that encapsulates one or more “behavior features.” Each behavior feature may be a symbol or number (abstract number, etc.) that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used. As an example, the behavior vector may include a “location” data field whose value identifies the number or rate that the software application is predicted to attempt to access location information per hour. The behavior vector may also include a “premium SMS” data field whose value that indicates whether the software application is likely to attempt sending premium SMS messages.

The predictive analyzer component 206 may be configured to generate static analysis results, and use the analysis results to determine whether a software application or device behavior is benign or non-benign (e.g., malicious, poorly written, performance-degrading, etc.). In some embodiments, the predictive analyzer component 206 may be configured to generate the static analysis results by applying the behavior vectors 232 to one or more classifier models. A classifier model may be a behavior model that includes data and/or information structures (e.g., feature vectors, component lists, decision nodes such as decision trees or stumps, etc.) that may be used by the computing device processor to evaluate a specific feature or embodiment of the device's behavior. A classifier model may also include decision criteria for monitoring and/or analyzing a number of features, factors, data points, entries, APIs, states, conditions, behaviors, software applications, processes, operations, components, etc. in the computing device.

In some embodiments, the predictive analyzer component 206 may be configured to generate and/or use various different types of machine learning classifier models. Such classifier models may include decision nodes (e.g., stumps) that evaluate/test dynamic features/conditions. Such classifier models may include evaluate static features or conditions. Such classifier models may include hybrid classifier models including decision nodes that evaluate a combination of static and dynamic features or conditions. Such classifier models may also include full classifier models, lean classifier models, locally generated classifier model, application-specific classifier models, device-specific classifier models, etc. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular mobile device behavior is not benign. A locally generated lean classifier model is a lean classifier model that is generated in the computing device. An application-specific classifier model is a classifier model that includes a focused data model that includes/tests only the features/entries that are most relevant for evaluating a particular software application. A device-specific classifier model is a classifier model that includes a focused data model that includes/tests only computing device-specific features/entries that are determined to be most relevant to classifying an activity or behavior in a specific computing device.

In some embodiments, the predictive analyzer component 206 may be configured to generate lean classifier models by converting a full classifier model or a finite state machine representation/expression into decision stumps (or other decision nodes), and using the decision stumps to intelligently analyze and/or classify a computing device behavior. As an example, a computing device may be configured to generate a lean classifier model (or a family of lean classifier models of varying levels of complexity) in the computing device based on a full or robust classifier model received from a server. The computing device may be configured to apply behavior vectors to the locally generated lean classifier model(s) to generate analysis results. The computing device may be configured to compute a weighted average value (e.g., 0.4) of the analysis results. The computing device may be configured to classify the behavior as benign in response to determining that the weighted average value exceeds a first threshold (e.g., is less than 0.1). The computing device may be configured to classify the behavior as non-benign in response to determining that the weighted average value exceeds a second threshold (e.g., is greater than 0.9). The computing device may be configured to classify the behavior as suspicious in response to determining that the behavior does not exceed the first or second thresholds.

The actuation component 208 may be configured to perform various operations (e.g., via a processor in the mobile computing device 102, etc.) to prevent, heal, cure, or otherwise respond or react to non-benign behaviors. For example, the actuation component 208 may be configured to terminate a software application or process when the result of applying the behavior information structure to the classifier model indicates that a software application or process is not benign. In addition, the actuation component 208 may include various components for invoking the features or operations of a runtime behavior monitoring and analysis system.

In the example illustrated in FIG. 2A, the actuation component 208 includes an application filter 226 component, a runtime, on-device and/or dynamic behavior analyzer 228 component, and a machine learning and/or behavior-based arbitrator 230 component. In some embodiments, these components 226-230 may be configured to communicate with and/or invoke specific operations in a runtime BMA system 250 (illustrated in FIG. 2B). For example, the application filter 226 component may be configured to invoke the operations of a behavior observer component 252 of the runtime BMA system 250 (illustrated in FIG. 2B). Similarly, the runtime, on-device and/or dynamic behavior analyzer 228 component may be configured to invoke the operations of the behavior analyzer component 256 of the runtime BMA system 250 (illustrated in FIG. 2B). The machine learning and/or behavior-based arbitrator 230 component may be configured to send, receive, evaluate or compare the analysis results generated by the predictive analyzer component 206 to the analysis result generated by the behavior analyzer component 256 (illustrated in FIG. 2B and discussed in more detail below).

FIG. 2B illustrates an example runtime behavior-based monitoring and analysis (BMA) system 250 that may be included in a computing device and configured to work in conjunction with a layered predictive analysis system (such as the LPA system 200 illustrated in FIG. 2A) to identify and respond to non-benign device behaviors. In the example illustrated in FIG. 2B, the computing device is a mobile computing device 102 that includes a device processor (i.e., mobile device processor) configured with executable instruction modules/components that include a behavior observer component 252, a behavior extractor component 254, a behavior analyzer component 256, and an actuator component 258. Each of the components 252-258 may be a thread, process, daemon, module, sub-system, or component that is implemented in software, hardware, or a combination thereof. In various embodiments, the components 252-258 may be implemented within parts of the operating system (e.g., within the kernel, in the kernel space, in the user space, etc.), within separate programs or applications, in specialized hardware buffers or processors, or any combination thereof. In an embodiment, one or more of the components 252-258 may be implemented as software instructions executing on one or more processors of the mobile computing device 102.

The behavior observer component 252 may be configured to instrument (e.g., via a processor in the mobile computing device 102, etc.) application programming interfaces (APIs) at various levels/modules of the device, and monitor the activities, conditions, operations, and events (e.g., system events, state changes, etc.) at the various levels/modules over a period of time via the instrumented APIs. The behavior observer component 252 may collect behavior information pertaining to the monitored activities, conditions, operations, or events, and store the collected information in a memory (e.g., in a log file, etc.). The behavior observer component 252 may communicate (e.g., via a memory write operation, function call, etc.) the collected behavior information to the behavior extractor component 254.

The behavior extractor component 254 may be configured to receive or retrieve the collected behavior information, and use this information to generate one or more behavior information structures (e.g., behavior vectors). In an embodiment, the behavior extractor component 254 may be configured to generate the behavior information structures to include a concise definition of the observed behaviors. For example, each behavior information structure may succinctly describe observed behavior of the mobile device, software application, or process in a value or vector data-structure (e.g., in the form of a string of numbers, etc.). The behavior extractor component 254 may also be configured to generate the behavior information structures so that they function as an identifier that enables the mobile device system (e.g., the behavior analyzer component 256) to quickly recognize, identify, and/or analyze mobile device behaviors.

The behavior analyzer component 256 may be configured to apply the behavior information structures to classifier models to determine if a device behavior is a non-benign behavior that is contributing to (or are likely to contribute to) the device's degradation over time and/or which may otherwise cause problems on the device. The behavior analyzer component 256 may notify the actuator component 258 that an activity or behavior is not benign. In response, the actuator component 258 may perform various actions or operations to heal, cure, isolate, or otherwise fix identified problems. For example, the actuator component 258 may be configured to terminate a software application or process when the result of applying the behavior information structure to the classifier model (e.g., by the analyzer component) indicates that a software application or process is not benign.

The behavior observer component 252 may be configured to monitor the activities of the mobile computing device 102. In various embodiments, this may be accomplished by monitoring various software and hardware components of the mobile computing device 102 and collecting information pertaining to the communications, transactions, events, or operations of the monitored and measurable components that are associated with the activities of the mobile computing device 102. Such activities include a software application's performance of an operation or task, a software application's execution in a processing core of the mobile computing device 102, the execution of process, the performance of a task or operation, a device behavior, the use of a hardware component, etc.

The behavior observer component 252 may be configured to monitor the activities of the mobile computing device 102 by collecting information pertaining to library API calls in an application framework or run-time libraries, system call APIs, file-system and networking sub-system operations, device (including sensor devices) state changes, and other similar events. In addition, the behavior observer component 252 may monitor file system activity, which may include searching for filenames, categories of file accesses (personal info or normal data files), creating or deleting files (e.g., type exe, zip, etc.), file read/write/seek operations, changing file permissions, etc.

The behavior observer component 252 may be configured to monitor the activities of the mobile computing device 102 by monitoring data network activity, which may include types of connections, protocols, port numbers, server/client that the device is connected to, the number of connections, volume or frequency of communications, etc. The behavior observer component 252 may monitor phone network activity, which may include monitoring the type and number of calls or messages (e.g., SMS, etc.) sent out, received, or intercepted (e.g., the number of premium calls placed).

The behavior observer component 252 may also monitor the activities of the mobile computing device 102 by monitoring the system resource usage, which may include monitoring the number of forks, memory access operations, number of files open, etc. The behavior observer component 252 may monitor the state of the mobile computing device 102, which may include monitoring various factors, such as whether the display is on or off, whether the device is locked or unlocked, the amount of battery remaining, the state of the camera, etc. The behavior observer component 252 may also monitor inter-process communications (IPC) by, for example, monitoring intents to crucial services (browser, contracts provider, etc.), the degree of inter-process communications, pop-up windows, etc.

The behavior observer component 252 may also monitor the activities of the mobile computing device 102 by monitoring driver statistics and/or the status of one or more hardware components. Monitored hardware components may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the mobile computing device 102.

The behavior observer component 252 may also monitor the activities of the mobile computing device 102 by monitoring one or more hardware counters that denote the state or status of the mobile computing device 102 and/or computing device sub-systems. A hardware counter may include a special-purpose register of the processors/cores that is configured to store a count value or state of hardware-related activities or events occurring in the mobile computing device 102.

The behavior observer component 252 may also monitor the activities of the mobile computing device 102 by monitoring the actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth, WiFi, etc.), content of text-based communications, content of recorded audio files, phonebook or contact information, contacts lists, etc.

The behavior observer component 252 may also monitor the activities of the mobile computing device 102 by monitoring transmissions or communications of the mobile computing device 102, including communications that include voicemail (VoiceMailComm), device identifiers (DeviceIDComm), user account information (UserAccountComm), calendar information (CalendarComm), location information (LocationComm), recorded audio information (RecordAudioComm), accelerometer information (AccelerometerComm), etc.

The behavior observer component 252 may also monitor the activities of the mobile computing device 102 by monitoring the usage of, and updates/changes to, compass information, computing device settings, battery life, gyroscope information, pressure sensors, magnet sensors, screen activity, etc. The behavior observer component 252 may monitor notifications communicated to and from a software application (AppNotifications), application updates, etc. The behavior observer component 252 may monitor conditions or events pertaining to a first software application requesting the downloading and/or install of a second software application. The behavior observer component 252 may monitor conditions or events pertaining to user verification, such as the entry of a password, etc.

The behavior observer component 252 may also monitor the activities of the mobile computing device 102 by monitoring conditions or events at multiple levels of the mobile computing device 102, including the application level, radio level, and sensor level. Application level observations may include observing the user via facial recognition software, observing social streams, observing notes entered by the user, observing events pertaining to the use of PassBook®, Google® Wallet, Paypal®, and other similar applications or services. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc.

Radio level observations may include determining the presence, existence or amount of any or more of user interaction with the mobile computing device 102 before establishing radio communication links or transmitting information, dual/multiple subscriber identification module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

Sensor level observations may include monitoring a magnet sensor or other sensor to determine the usage and/or external environment of the mobile computing device 102. For example, the computing device processor may be configured to determine whether the device is in a holster (e.g., via a magnet sensor configured to sense a magnet within the holster) or in the user's pocket (e.g., via the amount of light detected by a camera or light sensor). Detecting that the mobile computing device 102 is in a holster may be relevant to recognizing suspicious behaviors, for example, because activities and functions related to active usage by a user (e.g., taking photographs or videos, sending messages, conducting a voice call, recording sounds, etc.) occurring while the mobile computing device 102 is holstered could be signs of nefarious processes executing on the device (e.g., to track or spy on the user).

Other examples of sensor level observations related to usage or external environments may include, detecting near field communication (NFC) signaling, collecting information from a credit card scanner, barcode scanner, or mobile tag reader, detecting the presence of a Universal Serial Bus (USB) power charging source, detecting that a keyboard or auxiliary device has been coupled to the mobile computing device 102, detecting that the mobile computing device 102 has been coupled to another computing device (e.g., via USB, etc.), determining whether an LED, flash, flashlight, or light source has been modified or disabled (e.g., maliciously disabling an emergency signaling app, etc.), detecting that a speaker or microphone has been turned on or powered, detecting a charging or power event, detecting that the mobile computing device 102 is being used as a game controller, etc. Sensor level observations may also include collecting information from medical or healthcare sensors or from scanning the user's body, collecting information from an external sensor plugged into the USB/audio jack, collecting information from a tactile or haptic sensor (e.g., via a vibrator interface, etc.), collecting information pertaining to the thermal state of the mobile computing device 102, etc.

To reduce the number of factors monitored to a manageable level, in an embodiment, the behavior observer component 252 may be configured to perform coarse observations by monitoring/observing an initial set of behaviors or factors that are a small subset of all factors that could contribute to the computing device's degradation. In an embodiment, the behavior observer component 252 may be configured to receive the initial set of behaviors and/or factors from a server and/or a component in a cloud service or network. In an embodiment, the initial set of behaviors/factors may be specified in machine learning classifier models.

The behavior analyzer component 256 may be configured to apply the behavior information structures generated by the behavior extractor component 254 to a classifier model to generate results that may be used to determine whether a monitored activity (or behavior) is benign, suspicious, or non-benign. In an embodiment, the behavior analyzer component 256 may classify a behavior as “suspicious” when the results of its behavioral analysis operations do not provide sufficient information to classify the behavior as either benign or non-benign.

The behavior analyzer component 256 may be configured to notify the behavior observer component 252 in response to determining that a monitored activity or behavior is suspicious. In response, the behavior observer component 252 may adjust the granularity of its observations (i.e., the level of detail at which computing device features are monitored) and/or change the factors/behaviors that are observed based on information received from the behavior analyzer component 256 (e.g., results of the real-time analysis operations), generate or collect new or additional behavior information, and send the new/additional information to the behavior analyzer component 256 for further analysis/classification. Such feedback communications between the behavior observer component 252 and the behavior analyzer component 256 enable the mobile computing device 102 to recursively increase the granularity of the observations (i.e., make finer or more detailed observations) or change the features/behaviors that are observed until an activity is classified, a source of a suspicious or performance-degrading computing device behavior is identified, until a processing or battery consumption threshold is reached, or until the computing device processor determines that the source of the suspicious or performance-degrading computing device behavior cannot be identified from further increases in observation granularity. Such feedback communication also enable the mobile computing device 102 to adjust or modify the classifier models locally in the computing device without consuming an excessive amount of the computing device's processing, memory, or energy resources.

In an embodiment, the behavior observer component 252 and the behavior analyzer component 256 may provide, either individually or collectively, real-time behavior analysis of the computing system's behaviors to identify suspicious behavior from limited and coarse observations, to dynamically determine behaviors to observe in greater detail, and to dynamically determine the level of detail required for the observations. This allows the mobile computing device 102 to efficiently identify and prevent problems without requiring a large amount of processor, memory, or battery resources on the device.

In various embodiments, the device processor may be configured to work in conjunction with a network server to intelligently and efficiently identify the features, factors, and data points that are most relevant to determining whether an activity is a critical activity and/or not benign. For example, the device processor may be configured to receive a full classifier model from the network server, and use the received full classifier model to generate lean classifier models (i.e., data/behavior models) that are specific for the features and functionalities of the computing device or the software applications of the computing device. The device processor may use the full classifier model to generate a family of lean classifier models of varying levels of complexity (or “leanness”). The leanest family of lean classifier models (i.e., the lean classifier model based on the fewest number of test conditions) may be applied routinely until a behavior is encountered that the model cannot categorize as either benign or not benign (and therefore is categorized by the model as suspicious). When a behavior is encountered that the model cannot categorize, a more robust (i.e., less lean) lean classifier model may be applied in an attempt to categorize the behavior. The application of ever more robust lean classifier models within the family of generated lean classifier models may be applied until a definitive classification of the behavior is achieved. In this manner, the observer and/or analyzer modules/components can strike a balance between efficiency and accuracy by limiting the use of the most complete, but resource-intensive lean classifier models to those situations where a robust classifier model is needed to definitively classify a behavior.

In various embodiments, the device processor may be configured to monitor, analyze, and/or classify activities or behaviors by receiving (e.g., from a server, etc.) a full classifier model that is suitable for conversion or expression as a plurality of boosted decision stumps and generating a lean classifier model in the computing device based on the full classifier. The device processor may be configured to use the lean classifier model in the computing device to classify the activities or behaviors as being either benign or not benign. For example, the device processor may be configured to receive a large boosted-decision-stumps classifier model that includes decision stumps associated with a full feature set of behavior models (e.g., classifiers), and derive one or more lean classifier models from the large classifier models by selecting only features or decision stumps from the large classifier model(s) that are relevant the computing device's current configuration, functionality, operating state and/or connected/included hardware. The device processor may be configured to include in the lean classifier model a subset of boosted decision stumps that correspond to the selected features.

Boosted decision stumps are one level decision trees that have exactly one node (and thus one test question or test condition) and a weight value, and thus are well suited for use in a binary classification of data/behaviors. That is, applying a behavior information structure to boosted decision stump results in a binary answer (e.g., Yes or No). For example, if the question/condition tested by a boosted decision stump is “is the frequency of Short Message Service (SMS) transmissions less than x per minute,” applying a value of “3” to the boosted decision stump will result in either a “yes” answer (for “less than 3” SMS transmissions) or a “no” answer (for “3 or more” SMS transmissions). Boosted decision stumps are efficient because they are very simple and primal (and thus do not require significant processing resources). Boosted decision stumps are also very parallelizable, and thus many stumps may be applied or tested in parallel/at the same time (e.g., by multiple cores or processors in the computing device).

In an embodiment, the device processor may be configured to determine a number of unique test conditions that should be evaluated in order to classify a behavior without consuming an excessive amount of the device's resources (e.g., processing, memory, or energy resources). For example, the device processor may sequentially traverse a plurality of test conditions (e.g., included in a full classifier model), identify test conditions that are relevant to classifying the behavior of the computing device, insert the identified test conditions into the list of test conditions until the list of test conditions includes the determined number of unique test conditions, and generate the lean classifier model to include only decision nodes that test one of the conditions in the generated list of test conditions.

In various embodiments, the device processor may be configured to monitor, analyze, and/or classify activities or behaviors by using device-specific information, such as capability and state information. For example, the device processor may be configured to identify device-specific test conditions (from a plurality of test conditions identified in a full classifier model) that are relevant to classifying a behavior of the computing device, and generate a lean classifier model that includes only the identified computing device-specific test conditions.

In an embodiment, the device processor may be configured to generate the lean classifier model to include only decision nodes that evaluate features relevant to a current operating state or configuration of the computing device.

In various embodiments, the device processor may be configured to monitor, analyze, and/or classify activities or behaviors by monitoring an activity of a software application or process, determining an execution state of the software application/process, and determining whether the activity is benign or not benign based on the activity and/or the execution state of the software application during which the activity was monitored.

In various embodiments, the device processor may be configured to dynamically generate classifier models that identify conditions or features that are relevant to a specific software application (Google® wallet) and/or to a specific type of software application (e.g., games, navigation, financial, news, productivity, etc.). These classifier models may be generated to include a reduced and more focused subset of the decision nodes that are included in a full classifier model or of those included in a lean classifier model generated based on the full classifier model.

In various embodiments, the device processor may be configured to generate application-based classifier models for each software application in the system and/or for each type of software application in the system. The device processor may also be configured to dynamically identify the software applications and/or application types that are susceptible to abuse (e.g., financial applications, point-of-sale applications, biometric sensor applications, etc.), and generate application-based classifier models for only the software applications and/or application types that are susceptible to abuse. In various embodiments, device processor may be configured to generate classifier models dynamically, reactively, proactively, and/or every time a new application is installed or updated.

In various embodiments, the device processor may be configured to generate the behavior information structures to include information that may be input to a decision node in the machine learning classifier to generate an answer to a query regarding the monitored activity. The device processor may generate the behavior information structures to include a concise definition of the observed/monitored behaviors. The behavior information structure may succinctly describe an observed behavior of the computing device, software application, or process in a value or vector data-structure (e.g., in the form of a string of numbers, etc.). The behavior information structure may also function as an identifier that enables the computing device system to quickly recognize, identify, and/or analyze computing device behaviors.

In various embodiments, the device processor may be configured to generate the behavior information structures to include a plurality or series of numbers, each of which signifies or characterizes a feature, activity, or a behavior of the computing device. For example, numbers included in the behavior information structure may signify whether a camera of the computing device is in use (e.g., as zero or one), how much network traffic has been transmitted from or generated by the computing device (e.g., 20 KB/sec, etc.), how many internet messages have been communicated (e.g., number of SMS messages, etc.), etc.

In various embodiments, the device processor may be configured to generate the behavior information structures to include execution information. The execution information may be included in the behavior information structure as part of a behavior (e.g., camera used 5 times in 3 second by a background process, camera used 3 times in 3 second by a foreground process, etc.) or as part of an independent feature. In an embodiment, the execution state information may be included in the behavior information structure as a shadow feature value sub-vector or data structure. In an embodiment, the behavior information structure may store the shadow feature value sub-vector/data structure in association with the features, activities, tasks for which the execution state is relevant.

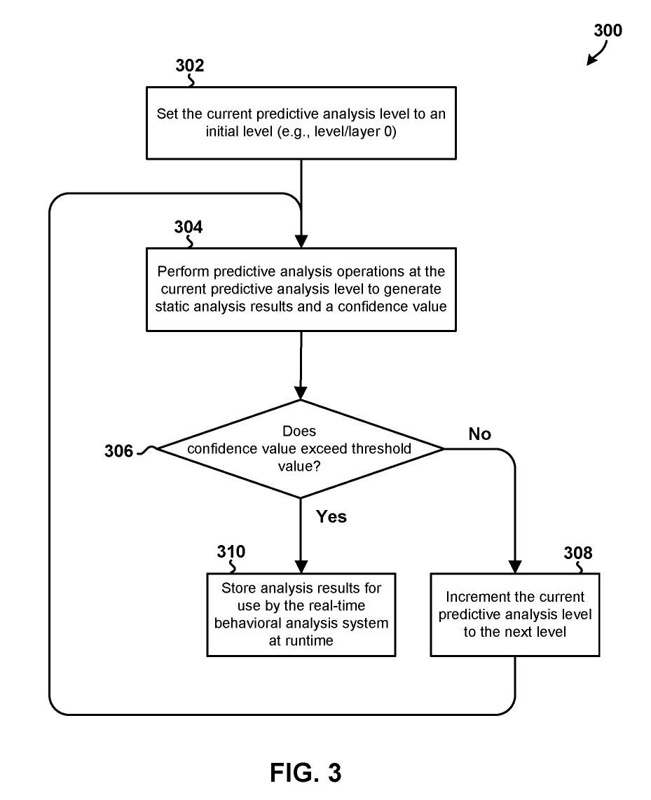

FIG. 3A illustrates a predictive analysis method 300 for analyzing anticipated behaviors in layers in accordance with an embodiment. The predictive analysis method 300 may be performed by a processor or processing core in mobile computing device 102 that includes a predictive analysis system (LPA system) 200. Method 300 may be performed in advance of runtime or before the relevant software application commences execution on the computing device.

In block 302, the processor may set the current predictive analysis level to an initial level (e.g., level/layer 0). In block 304, the processor may perform predictive analysis operations at the current predictive analysis level (e.g., level/layer 0) to generate static analysis results and a confidence value (e.g., 0.1, 50%, etc.) that identifies the probability that the analysis results could be used to accurately or conclusively classify a behavior as benign or non-benign.

In determination block 306, the processor may determine whether the confidence value exceeds a threshold value.

In response to determining that the confidence value exceeds the threshold value (i.e., determination block 306=“Yes”), the processor may store analysis results for use during runtime by the real-time behavioral analysis system (or behavior-based analysis system) in block 310.

In response to determining that the confidence value does not exceed the threshold value (i.e., determination block 306=“No”), the processor may increment the current predictive analysis level to the next level in block 308 and perform predictive analysis operations at the current predictive analysis level in block 304.

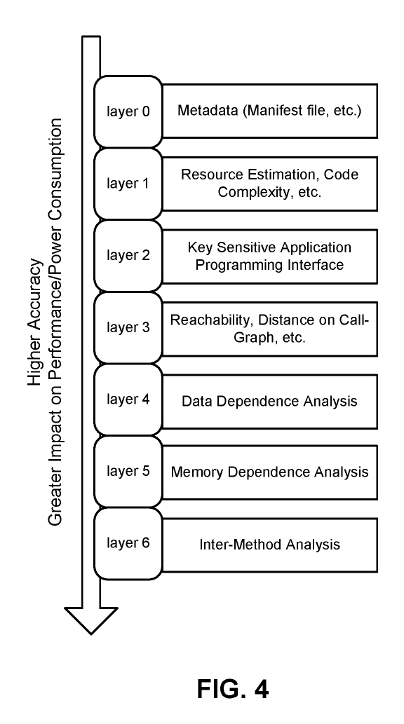

FIG. 4 illustrates various levels or layers that may be included in a layered predictive analysis system (e.g., LPA system 200, etc.) that is configured to evaluate device behaviors and software applications in accordance with the various embodiments. The computing device and/or predictive analysis system may be configured to first analyze the software application at a high level or low layer (e.g., layer 0) to reduce or minimize any negative or user-perceivable impact such operations may have on the performance and power consumption characteristics of the device. If the computing device/system determines that the behavior or software application can be classified as benign or non-benign with a sufficiently high degree of confidence based on these results, computing device/system may forgo performing further analysis operations and/or select a new behavior/software application for analysis. On the other hand, if the computing device/system determines that the behavior or software application could not be classified as benign or non-benign with a sufficiently high degree of confidence based on the analysis results (i.e., layer 0 results), the computing device/system may progressively decrease the level (or increase the layer) at which the behaviors are observed and analyzed until the analysis results indicate that behavior may be classified as benign or non-benign with a high degree of confidence, until the highest level is reached, or until a processing or power consumption threshold is reached.

In the example illustrated in FIG. 4, at the highest level or lowest layer (i.e., layer 0), the computing device analyzes metadata (a manifest file, etc.) because these operations have little or no impact on the performance or power consumption characteristics of the device. At the next level/layer (i.e., layer 1), the computing device analyzes resource estimates, code complexity, and other similar information/factors that provide better analysis results but which have a slightly greater impact on the performance or power consumption characteristics of the device (e.g., consume more of the device processing and/or battery resources, etc.). Similarly, in layers 2 through 6, the computing device monitors/analyzes key sensitive APIs, reachability information, distances on call-graphs, data dependence, memory dependence, inter-method relationships, and other similar information/factors that provide progressively better information, but which progressively consume more of the device processing and/or battery resources (and thus have an increasing negative impact on the performance or power consumption characteristics of the device).

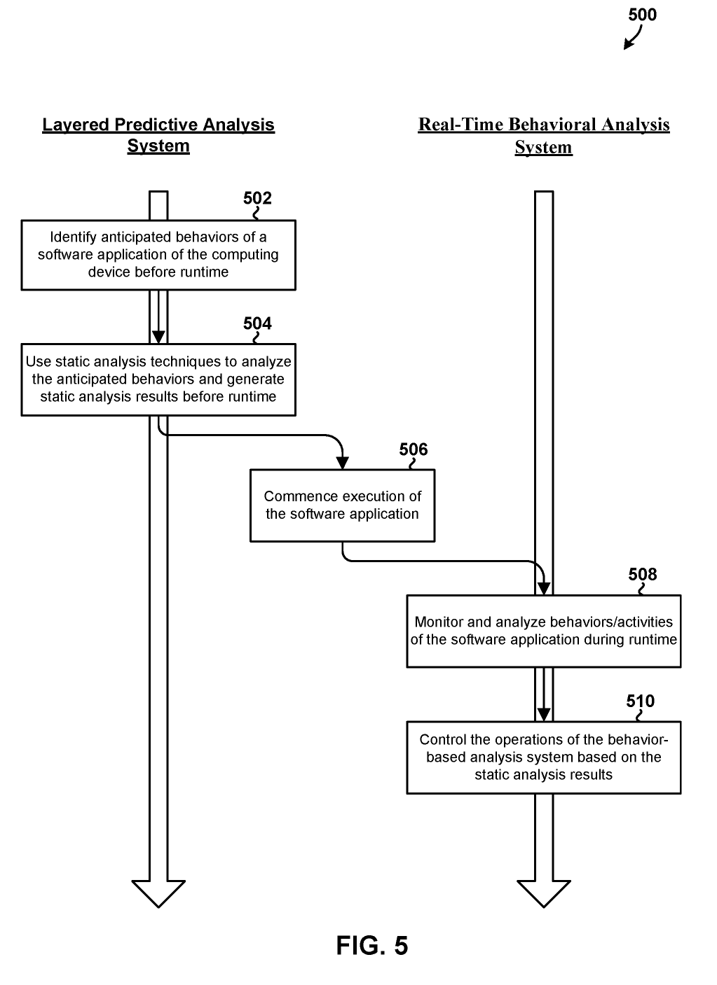

FIG. 5 illustrates a method 500 for using a combination of predictive and real-time behavioral analysis techniques to protect a computing device (e.g., mobile computing device 102, etc.) from malware and other non-benign behaviors in accordance with an embodiment. The method 500 may be performed by a processor or processing core in mobile computing device 102 that includes a predictive analysis system (e.g., LPA system 200) and a runtime or real-time behavioral analysis system (e.g., runtime BMA system 250).

In block 502, the predictive analysis system may identify (e.g., via the processor) anticipated behaviors of a software application of the computing device before runtime. For example, prior to runtime, the predictive analysis system may predict that the software application will access communications circuitry and/or attempt to send premium SMS messages.

In block 504, the predictive analysis system may use static analysis techniques (static program analysis) to analyze the anticipated behaviors and generate static analysis results before/prior to runtime. For example, prior to runtime, the predictive analysis system may evaluate source code associated with the software application to determine/predict how frequently the software application will attempt to activate the communication circuitry, the number of times it will attempt to send SMS messages within a time period, the types of resources it will attempt to access prior to sending the SMS messages, whether it will attempt to read information from a contact book prior to attempting to send SMS messages, etc. The predictive analysis system may then determine whether these anticipated behaviors may be classified as benign, suspicious or non-benign. The predictive analysis system may also generate static analysis results that classify each anticipated behavior as benign, suspicious or non-benign.

In some embodiments, in block 504, the processor may classify, before runtime and based on the static analysis results, an anticipated behavior of the software to generate a static analysis behavior classification (e.g., a classification of “benign” or “non-benign” based on the static analysis operations), and compute a first confidence value that identifies a probability that the static analysis behavior classification of that anticipated behavior is accurate.

In block 506, the processor may commence execution of the software application on the computing device. For example, an operating system of the computing device may load the software application program into a memory so that it can be accessed and executed by the processor and/or the runtime system of the computing device.

In block 508, the real-time behavior-based analysis system may (e.g., via the processor) monitor and analyze behaviors/activities of the software application during runtime (i.e., as the application executes on the runtime system). As part of these operations, the behavior-based analysis system may analyze the activities of the software application and generate dynamic analysis results. The dynamic analysis results may include the results generated by applying a behavior vector information structure to a machine learning classifier model that includes decision nodes that test/evaluate various devices conditions or features.

In some embodiments, in block 508, the processor may classify, during runtime, a corresponding behavior/activity of the software application (e.g., an activity that corresponds to the anticipated behavior) based on the dynamic analysis results to generate a dynamic analysis behavior classification (e.g., a classification of “benign” or “non-benign” based on the dynamic analysis operations), and compute a second confidence value that identifies the probability that the dynamic analysis behavior classification of the corresponding behavior/activity is accurate.

In block 510, the processor or real-time behavior-based analysis system may control the operations of the behavior-based analysis system based on the static analysis results generated in advance of runtime by the predictive analysis system. For example, based on the static analysis results, the processor may forgo further analysis of an ongoing activity/behavior that corresponds to an anticipated behavior that the predictive analysis system classified as benign. As another example, the processor or behavior-based analysis system may select for analysis one or more of the anticipated behaviors that the predictive analysis system classified as suspicious.

In some embodiments, in block 510, the processor may control the operations of the behavior-based analysis system based on the static analysis results by determining whether the first confidence value exceeds the second confidence value, using the static analysis behavior classification in response to determining that the first confidence value exceeds the second confidence value, and using the dynamic analysis behavior classification in response to determining that the first confidence value does not exceed the second confidence value.

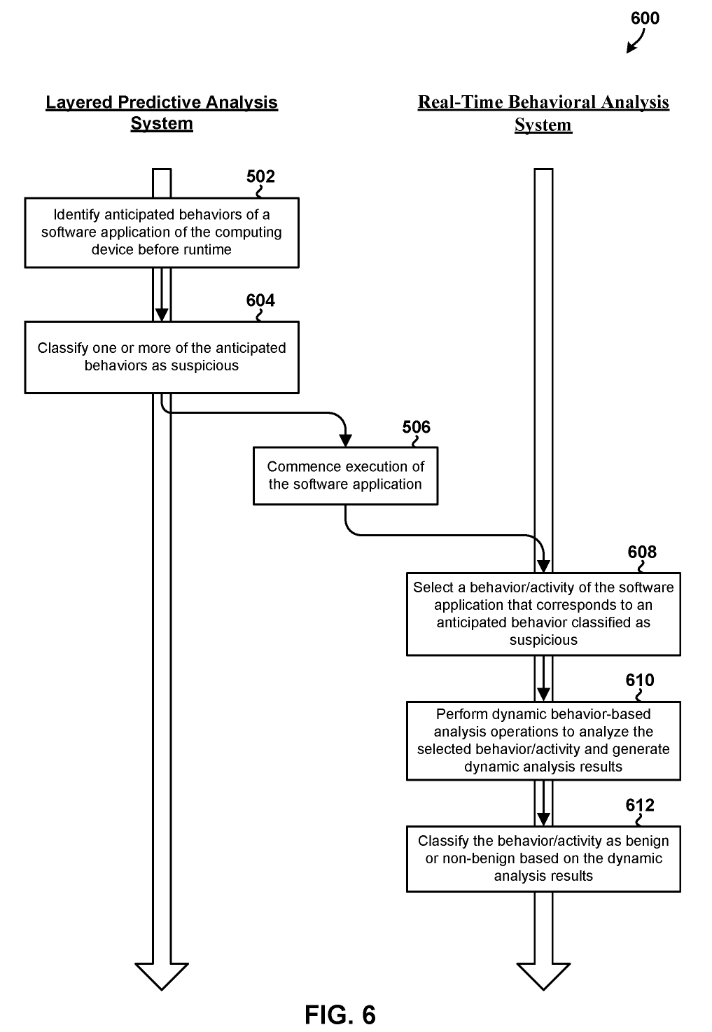

FIG. 6 illustrates a method 600 for protecting a computing device (e.g., mobile computing device 102, etc.) from malware and other non-benign behaviors in accordance with another embodiment. The method 600 may be performed by a processor or processing core in mobile computing device 102 that includes a predictive analysis system (e.g., LPA system 200) and a runtime or real-time behavior-based analysis system (e.g., runtime BMA system 250). In block 502, the predictive analysis system may identify (e.g., via the processor) anticipated behaviors of a software application of the computing device before runtime. In block 604, the predictive analysis system may use static analysis techniques to analyze the anticipated behaviors, generate static analysis results (e.g., a first behavior vector that includes static behavior information, a numerical value that is suitable for comparison to various threshold values, etc.), and use the generated static analysis results to classify one or more of the anticipated behaviors as suspicious.

In block 506, the processor may commence execution of the software application on the computing device. In block 608, the real-time behavior-based analysis system may select (e.g., via the processor) a behavior of the software application that corresponds to an anticipated behavior that was classified as suspicious by the predictive analysis system in block 604. Said another way, in block 608, the real-time behavior-based analysis system may filter or select the applications or behaviors that are monitored or evaluated by the real-time behavior-based analysis system, forgo analyzing behaviors/activities that the predictive analysis system classified as benign (e.g., safe, good, expected, etc.), and/or forgo analyzing behaviors/activities that the predictive analysis system classified as non-benign (e.g., known to be harmful, malware, etc.). This allows the computing device to avoid performing spurious operations and focus runtime analysis operations on the behaviors that are most likely to degrade the device's performance and power consumption over time.

In block 610, the real-time behavior-based analysis system may perform dynamic and real-time behavior-based analysis operations to analyze the selected behavior and generate dynamic analysis results (e.g., a second behavior vector that includes dynamic behavior information, a second numerical value that is suitable for comparison to various threshold values, results of apply a behavior vector to a classifier model, etc.).

In block 612, the real-time behavior-based analysis system may classify the behavior as benign or non-benign based on the dynamic analysis results.

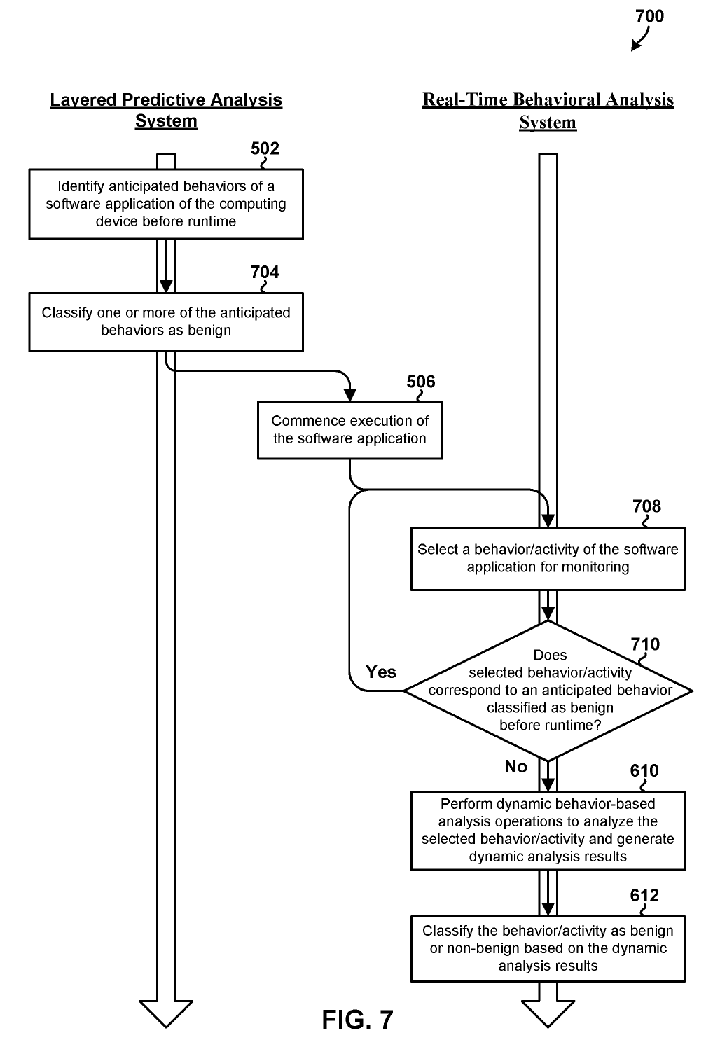

FIG. 7 illustrates a method 700 for protecting a computing device (e.g., mobile computing device 102, etc.) from malware and other non-benign behaviors in accordance with yet another embodiment. The method 700 may be performed by a processor or processing core in mobile computing device 102 that includes a predictive analysis system (e.g., LPA system 200) and a runtime or real-time behavior-based analysis system (e.g., runtime BMA system 250).

In block 502, the predictive analysis system may identify (e.g., via the processor) anticipated behaviors of a software application of the computing device before runtime.

In block 704, the predictive analysis system may use static analysis techniques to analyze the anticipated behaviors, generate static analysis results, and use the generated static analysis results to classify one or more of the anticipated behaviors as benign (or non-benign).

In block 506, the processor may commence execution of the software application on the computing device.

In block 708, the real-time behavior-based analysis system may select (e.g., via the processor) a behavior of the software application for monitoring.

In determination block 710, the real-time behavior-based analysis system may determine whether the selected behavior corresponds to an anticipated behavior classified as benign by the predictive analysis system.

In response to determining that the selected behavior corresponds to an anticipated behavior classified as benign by the predictive analysis system (i.e., determination block 710=“Yes”), the real-time behavior-based analysis system may forgo analyzing the selected behavior and select a new behavior for monitoring in block 708.

In response to determining that the selected behavior does not correspond to any of the anticipated behaviors that the predictive analysis system classified as benign before runtime (i.e., determination block 710=“No”), the real-time behavior-based analysis system may perform dynamic and real-time behavior-based analysis operations to analyze the selected behavior and generate dynamic analysis results in block 610.

In block 612, the real-time behavior-based analysis system may classify the behavior as benign or non-benign based on the dynamic analysis results.

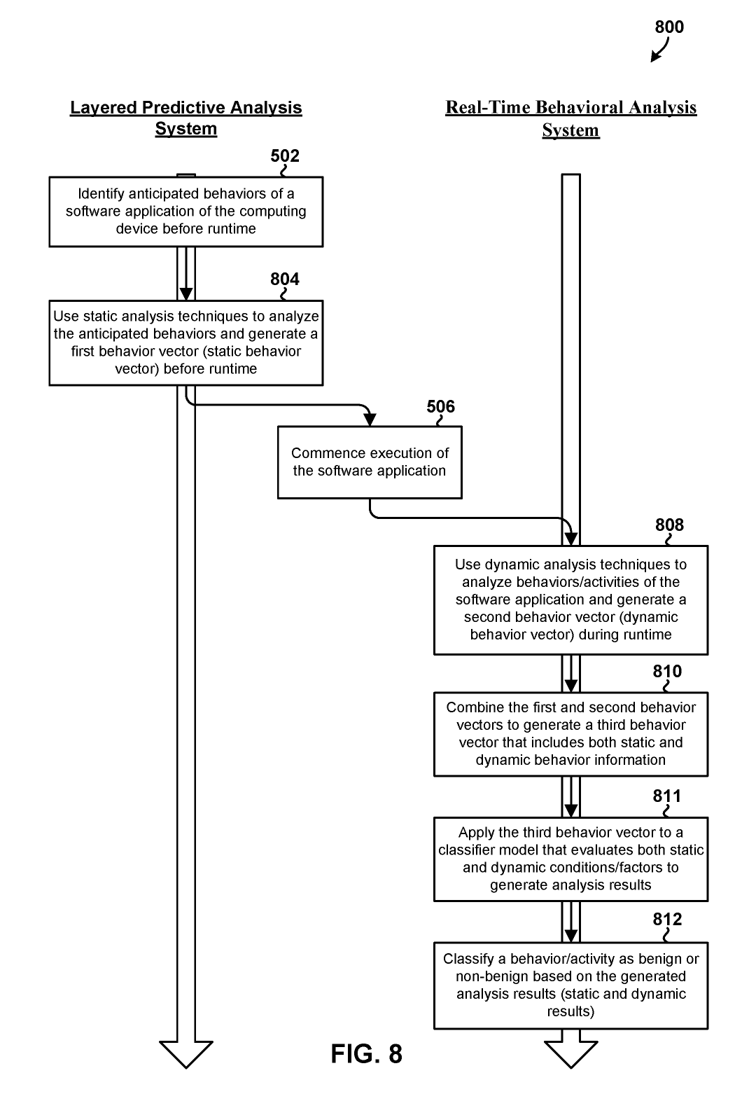

FIG. 8 illustrates a method 800 for protecting a computing device (e.g., mobile computing device 102, etc.) from malware and other non-benign behaviors in accordance with another embodiment. The method 800 may be performed by a processor or processing core in mobile computing device 102 that includes a predictive analysis system (e.g., LPA system 200) and a runtime or real-time behavior-based analysis system (e.g., runtime BMA system 250).

In block 502, the predictive analysis system may identify (e.g., via the processor) anticipated behaviors of a software application of the computing device before runtime.

In block 804, the predictive analysis system may use static analysis techniques to analyze the anticipated behaviors and generate a first behavior vector (static behavior vector) before runtime. For example, in block 804, prior to runtime, the predictive analysis system may analyze the anticipated behaviors to generate static analysis results that include a first behavior vector that includes static behavior information.

In block 506, the processor may commence execution of the software application on the computing device/runtime system.

In block 808, the processor or real-time behavior-based analysis system may (e.g., via the processor) use dynamic analysis techniques to analyze behaviors of the software application and generate a second behavior vector (dynamic behavior vector) during runtime. For example, the real-time behavior-based analysis system may monitor/analyze the activities of the software application as it executes on the runtime system, and generate a second behavior vector that includes dynamic behavior information that is collected or generated at runtime.

In block 810, the processor or real-time behavior-based analysis system may combine the first and second behavior vectors to generate a third behavior vector that includes both static and dynamic behavior information.

In block 811, the processor or real-time behavior-based analysis system may apply the third behavior vector to a classifier model (e.g., full classifier model, lean classifier model, etc.) that includes decision nodes that evaluate both static and dynamic conditions/factors. Applying the third behavior vector to the classifier model will generate analysis results that account for both static and dynamic aspects of the software application (or its behaviors/activities).

In block 812, the real-time behavior-based analysis system may classify the behavior as benign or non-benign based on the generated analysis results (static and dynamic results).

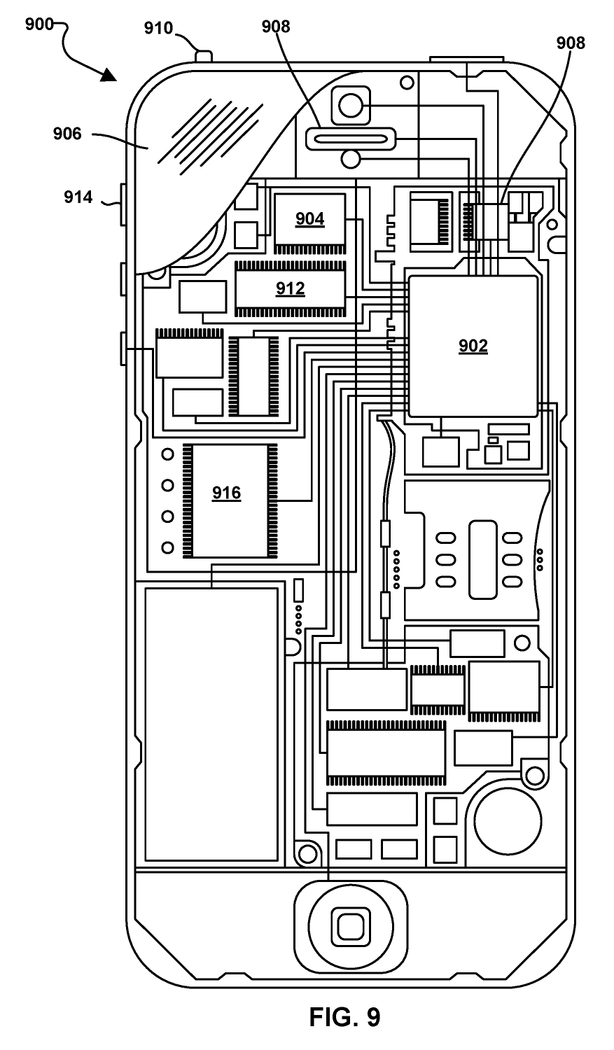

The various embodiments may be implemented on a variety of mobile devices, an example of which is illustrated in FIG. 9. Specifically, FIG. 9 is a system block diagram of a client computing device in the form of a smartphone/cell phone 900 suitable for use with any of the embodiments. The cell phone 900 may include a processor 902 coupled to internal memory 904, a display 906, and a speaker 908. Additionally, the cell phone 900 may include an antenna 910 for sending and receiving electromagnetic radiation that may be connected to a wireless data link and/or cellular telephone (or wireless) transceiver 912 coupled to the processor 902. Cell phones 900 typically also include menu selection buttons or rocker switches 914 for receiving user inputs.

A typical cell phone 900 also includes a sound encoding/decoding (CODEC) circuit 916 that digitizes sound received from a microphone into data packets suitable for wireless transmission and decodes received sound data packets to generate analog signals that are provided to the speaker 908 to generate sound. Also, one or more of the processor 902, wireless transceiver 912 and CODEC 916 may include a digital signal processor (DSP) circuit (not shown separately). The cell phone 900 may further include a ZigBee transceiver (i.e., an Institute of Electrical and Electronics Engineers (IEEE) 802.15.4 transceiver) for low-power short-range communications between wireless devices, or other similar communication circuitry (e.g., circuitry implementing the Bluetooth® or WiFi protocols, etc.).

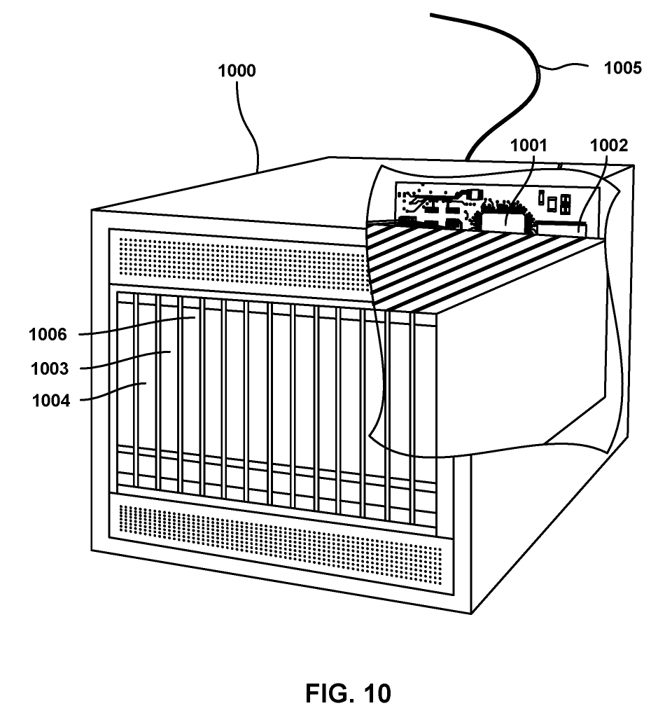

The embodiments and servers described above may be implemented in variety of commercially available server devices, such as the server 1000 illustrated in FIG. 10. Such a server 1000 typically includes a processor 1001 coupled to volatile memory 1002 and a large capacity nonvolatile memory, such as a disk drive 1003. The server 1000 may also include a floppy disc drive, compact disc (CD) or digital versatile disc (DVD) disc drive 1004 coupled to the processor 1001. The server 1000 may also include network access ports 1006 coupled to the processor 1001 for establishing data connections with a network 1005, such as a local area network coupled to other communication system computers and servers.

The processors 902, 1001, may be any programmable microprocessor, microcomputer or multiple processor chip or chips that can be configured by software instructions (applications) to perform a variety of functions, including the functions of the various embodiments described below. In some client computing devices, multiple processors 902 may be provided, such as one processor dedicated to wireless communication functions and one processor dedicated to running other applications. Typically, software applications may be stored in the internal memory 904, 1002, before they are accessed and loaded into the processor 902, 1001. The processor 902 may include internal memory sufficient to store the application software instructions. In some servers, the processor 1001 may include internal memory sufficient to store the application software instructions. In some receiver devices, the secure memory may be in a separate memory chip coupled to the processor 1001. The internal memory 904, 1002 may be a volatile or nonvolatile memory, such as flash memory, or a mixture of both. For the purposes of this description, a general reference to memory refers to all memory accessible by the processor 902, 1001, including internal memory 904, 1002, removable memory plugged into the device, and memory within the processor 902, 1001 itself.

The various embodiments discussed in this application are especially well suited for use in resource constrained-computing devices, such as client computing devices, because the task of intelligently detecting malware is primarily delegated to the detonator server, because they do not require evaluating a very large corpus of behavior information on the client computing devices, generate classifier/behavior models dynamically to account for device-specific or application-specific features of the computing device, intelligently prioritize the features that are tested/evaluated by the classifier/behavior models, are not limited to evaluating an individual application program or process, intelligently identify the factors or behaviors that are to be monitored by the computing device, accurately and efficiently classify the monitored behaviors, and/or do not require the execution of computationally-intensive processes. For all these reasons, the various embodiments may be implemented or performed in a resource-constrained computing device without having a significant negative and/or user-perceivable impact on the responsiveness, performance, or power consumption characteristics of the device.

For example, modern client computing devices are highly configurable and complex systems. As such, the factors or features that are most important for determining whether a particular device behavior is benign or not benign (e.g., malicious or performance-degrading) may be different in each client computing device. Further, a different combination of factors/features may require monitoring and/or analysis in each client computing device in order for that device to quickly and efficiently determine whether a particular behavior is benign or not benign. Yet, the precise combination of factors/features that require monitoring and analysis, and the relative priority or importance of each feature or feature combination, can often only be determined using device-specific information obtained from the specific computing device in which the behavior is to be monitored or analyzed. For these and other reasons, classifier models generated in any computing device other than the specific device in which they are used cannot include information that identifies the precise combination of factors/features that are most important to classifying a software application or device behavior in that specific device. That is, by generating classifier models in the specific computing device in which the models are used, the various embodiments generate improved models that better identify and prioritize the factors/features that are most important for determining whether a software application, process, activity or device behavior is benign or non-benign.

As used in this application, the terms “component,” “module,” “system” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of using a combination of predictive and behavior-based analysis to protect a mobile computing device, comprising:
identifying, before runtime via a processor of the mobile computing device, anticipated behaviors of a software application;
analyzing, before runtime via the processor, the anticipated behaviors to generate static analysis results;
commencing execution of the software application;
analyzing activities of the software application during runtime via a behavior-based analysis system executing in the processor to generate dynamic analysis results; and
controlling operations of the behavior-based analysis system based on the static analysis results.

2. The method of claim 1, wherein:
analyzing, before runtime via the processor, the anticipated behaviors to generate the static analysis results comprises classifying one or more of the anticipated behaviors as benign; and
controlling operations of the behavior-based analysis system based on the static analysis results comprises forgoing analysis of an activity that corresponds to an anticipated behavior classified as benign.

3. The method of claim 1, wherein:
analyzing, before runtime via the processor, the anticipated behaviors to generate the static analysis results comprises classifying one or more of the anticipated behaviors as suspicious; and
controlling operations of the behavior-based analysis system based on the static analysis results comprises selecting for analysis by the behavior-based analysis system an activity that corresponds to an anticipated behavior classified as suspicious.

4. The method of claim 1, wherein:
analyzing, before runtime via the processor, the anticipated behaviors to generate the static analysis results comprises generating a first behavior vector that includes static behavior information;
analyzing activities of the software application during runtime via the behavior-based analysis system comprises generating a second behavior vector that includes dynamic behavior information; and
controlling operations of the behavior-based analysis system based on the static analysis results comprises combining the first behavior vector and the second behavior vector to generate a third behavior vector that includes both static behavior information and dynamic behavior information.

5. The method of claim 1, further comprising:
classifying, before runtime via the processor, at least one of the anticipated behaviors based on the static analysis results to generate a static analysis behavior classification;
computing, via the processor, a first confidence value that identifies a probability that the static analysis behavior classification of the at least one anticipated behavior is accurate;
classifying, via the processor, a corresponding behavior of the software application during runtime based on the dynamic analysis results to generate a dynamic analysis behavior classification;
computing, via the processor, a second confidence value that identifies the probability that the dynamic analysis behavior classification of the corresponding behavior is accurate;
determining, via the processor, whether the first confidence value exceeds the second confidence value;
using the static analysis behavior classification in response to determining that the first confidence value exceeds the second confidence value; and
using the dynamic analysis behavior classification in response to determining that the first confidence value does not exceed the second confidence value.

6. The method of claim 1, further comprising:
determining, via the processor, probability values that each identify a likelihood of that one of the anticipated behaviors will be non-benign; and
prioritizing, via the processor, the anticipated behaviors based on the probability values,
wherein controlling operations of the behavior-based analysis system based on the static analysis results comprises causing the behavior-based analysis system to evaluate one or more behaviors of the software application based on the probability values.

7. The method of claim 6, further comprising:
determining, via the processor, a number of activities that could be evaluated at runtime without having a significant negative impact on a performance characteristic or a power consumption characteristic of the mobile computing device,
wherein controlling operations of the behavior-based analysis system based on the static analysis results further comprises causing the behavior-based analysis system to evaluate only the determined number of activities at runtime.

8. The method of claim 1, wherein analyzing, before runtime via the processor, the anticipated behaviors to generate the static analysis results comprises analyzing the anticipated behaviors in layers prior to runtime.

9. The method of claim 8, wherein analyzing the anticipated behaviors in layers prior to runtime comprises:
analyzing the anticipated behaviors at a first level to generate first results and a first confidence value;
determining whether the first confidence value exceeds a threshold value; and
analyzing the anticipated behaviors at a second level to generate second results and a second confidence value in response to determining that the first confidence value does not exceed the threshold value.

10. A mobile computing device, comprising:
a processor configured with processor-executable instructions to perform operations comprising:
identifying before runtime anticipated behaviors of a software application;
analyzing before runtime the anticipated behaviors to generate static analysis results;
commencing execution of the software application;
analyzing activities of the software application during runtime via a behavior-based analysis system to generate dynamic analysis results; and
controlling operations of the behavior-based analysis system based on the static analysis results.

11. The mobile computing device of claim 10, wherein the processor is configured with processor-executable instructions to perform operations such that:
analyzing before runtime the anticipated behaviors to generate the static analysis results comprises classifying one or more of the anticipated behaviors as benign; and
controlling operations of the behavior-based analysis system based on the static analysis results comprises forgoing analysis of an activity that corresponds to an anticipated behavior classified as benign.

12. The mobile computing device of claim 10, wherein the processor is configured with processor-executable instructions to perform operations such that:
analyzing before runtime the anticipated behaviors to generate the static analysis results comprises classifying one or more of the anticipated behaviors as suspicious; and
controlling operations of the behavior-based analysis system based on the static analysis results comprises selecting for analysis by the behavior-based analysis system an activity that corresponds to an anticipated behavior classified as suspicious.

13. The mobile computing device of claim 10, wherein the processor is configured with processor-executable instructions to perform operations such that:
analyzing before runtime the anticipated behaviors to generate the static analysis results comprises generating a first behavior vector that includes static behavior information;
analyzing activities of the software application during runtime via the behavior-based analysis system comprises generating a second behavior vector that includes dynamic behavior information; and
controlling operations of the behavior-based analysis system based on the static analysis results comprises combining the first behavior vector and the second behavior vector to generate a third behavior vector that includes both static behavior information and dynamic behavior information.

14. The mobile computing device of claim 10, wherein the processor is configured with processor-executable instructions to perform operations further comprising:
classifying before runtime at least one of the anticipated behaviors based on the static analysis results to generate a static analysis behavior classification;
computing a first confidence value that identifies a probability that the static analysis behavior classification of the at least one anticipated behavior is accurate;
classifying a corresponding behavior of the software application during runtime based on the dynamic analysis results to generate a dynamic analysis behavior classification;
computing a second confidence value that identifies the probability that the dynamic analysis behavior classification of the corresponding behavior is accurate;
determining whether the first confidence value exceeds the second confidence value;
using the static analysis behavior classification in response to determining that the first confidence value exceeds the second confidence value; and
using the dynamic analysis behavior classification in response to determining that the first confidence value does not exceed the second confidence value.

15. The mobile computing device of claim 10, wherein the processor is configured with processor-executable instructions to perform operations further comprising:
determining probability values that each identify a likelihood of that one of the anticipated behaviors will be non-benign; and
prioritizing the anticipated behaviors based on the probability values,
wherein the processor is configured with processor-executable instructions to perform operations such that controlling operations of the behavior-based analysis system based on the static analysis results comprises causing the behavior-based analysis system to evaluate one or more behaviors of the software application based on the probability values.

16. The mobile computing device of claim 15, wherein:
the processor is configured with processor-executable instructions to perform operations further comprising determining a number of activities that could be evaluated at runtime without having a significant negative impact on a performance characteristic or a power consumption characteristic of the mobile computing device; and
the processor is configured with processor-executable instructions to perform operations such that controlling operations of the behavior-based analysis system based on the static analysis results comprises causing the behavior-based analysis system to evaluate only the determined number of activities at runtime.

17. The mobile computing device of claim 10, wherein the processor is configured with processor-executable instructions to perform operations such that analyzing before runtime the anticipated behaviors to generate the static analysis results comprises analyzing the anticipated behaviors in layers prior to runtime.

18. The mobile computing device of claim 17, wherein the processor is configured with processor-executable instructions to perform operations such that analyzing the anticipated behaviors in layers prior to runtime comprises:
analyzing the anticipated behaviors at a first level to generate first results and a first confidence value;
determining whether the first confidence value exceeds a threshold value; and
analyzing the anticipated behaviors at a second level to generate second results and a second confidence value in response to determining that the first confidence value does not exceed the threshold value.

19. A non-transitory computer readable storage medium having stored thereon processor-executable software instructions configured to cause a processor of a mobile computing device to perform operations comprising:
identifying before runtime anticipated behaviors of a software application;
analyzing before runtime the anticipated behaviors to generate static analysis results;
commencing execution of the software application;
analyzing activities of the software application during runtime via a behavior-based analysis system executing in the processor to generate dynamic analysis results; and
controlling operations of the behavior-based analysis system based on the static analysis results.

20. The non-transitory computer readable storage medium of claim 19, wherein the stored processor-executable instructions are configured to cause a processor to perform operations such that:
analyzing before runtime the anticipated behaviors to generate the static analysis results comprises classifying one or more of the anticipated behaviors as benign; and
controlling operations of the behavior-based analysis system based on the static analysis results comprises forgoing analysis of an activity that corresponds to an anticipated behavior classified as benign.

21. The non-transitory computer readable storage medium of claim 19, wherein the stored processor-executable instructions are configured to cause a processor to perform operations such that:
analyzing before runtime the anticipated behaviors to generate the static analysis results comprises classifying one or more of the anticipated behaviors as suspicious; and
controlling operations of the behavior-based analysis system based on the static analysis results comprises selecting for analysis by the behavior-based analysis system only the anticipated behaviors classified as suspicious.

22. The non-transitory computer readable storage medium of claim 19, wherein the stored processor-executable instructions are configured to cause a processor to perform operations such that:
analyzing before runtime the anticipated behaviors to generate the static analysis results comprises generating a first behavior vector that includes static behavior information;
analyzing activities of the software application during runtime via the behavior-based analysis system comprises generating a second behavior vector that includes dynamic behavior information; and
controlling operations of the behavior-based analysis system based on the static analysis results comprises combining the first behavior vector and the second behavior vector to generate a third behavior vector that includes both static behavior information and dynamic behavior information.

23. The non-transitory computer readable storage medium of claim 19, wherein the stored processor-executable instructions are configured to cause a processor to perform operations further comprising:
classifying before runtime at least one of the anticipated behaviors based on the static analysis results to generate a static analysis behavior classification;
computing a first confidence value that identifies a probability that the static analysis behavior classification of the at least one anticipated behavior is accurate;
classifying a corresponding behavior of the software application during runtime based on the dynamic analysis results to generate a dynamic analysis behavior classification;
computing a second confidence value that identifies the probability that the dynamic analysis behavior classification of the corresponding behavior is accurate;
determining whether the first confidence value exceeds the second confidence value;
using the static analysis behavior classification in response to determining that the first confidence value exceeds the second confidence value; and
using the dynamic analysis behavior classification in response to determining that the first confidence value does not exceed the second confidence value.

24. The non-transitory computer readable storage medium of claim 19, wherein:
the stored processor-executable instructions are configured to cause a processor to perform operations further comprising:
determining probability values that each identify a likelihood of that one of the anticipated behaviors will be non-benign; and
prioritizing the anticipated behaviors based on the probability values; and
the stored processor-executable instructions are configured to cause a processor to perform operations such that controlling operations of the behavior-based analysis system based on the static analysis results comprises causing the behavior-based analysis system to evaluate one or more behaviors of the software application based on the probability values.

25. The non-transitory computer readable storage medium of claim 24, wherein:
the stored processor-executable instructions are configured to cause a processor to perform operations further comprising determining a number of activities that could be evaluated at runtime without having a significant negative impact on a performance characteristic or a power consumption characteristic of the mobile computing device; and
the stored processor-executable instructions are configured to cause a processor to perform operations such that controlling operations of the behavior-based analysis system based on the static analysis results further comprises causing the behavior-based analysis system to evaluate only the determined number of activities at runtime.

26. The non-transitory computer readable storage medium of claim 19, wherein the stored processor-executable instructions are configured to cause a processor to perform operations such that analyzing before runtime the anticipated behaviors to generate the static analysis results comprises analyzing the anticipated behaviors in layers prior to runtime.

27. The non-transitory computer readable storage medium of claim 26, wherein the stored processor-executable instructions are configured to cause a processor to perform operations such that analyzing the anticipated behaviors in layers prior to runtime comprises:
analyzing the anticipated behaviors at a first level to generate first results and a first confidence value;
determining whether the first confidence value exceeds a threshold value; and
analyzing the anticipated behaviors at a second level to generate second results and a second confidence value in response to determining that the first confidence value does not exceed the threshold value.

28. A mobile computing device, comprising:
means for identifying before runtime anticipated behaviors of a software application;
means for analyzing before runtime the anticipated behaviors to generate static analysis results;
means for commencing execution of the software application;
means for analyzing activities of the software application during runtime via a behavior-based analysis system executing to generate dynamic analysis results; and
means for controlling operations of the behavior-based analysis system based on the static analysis results.

29. The mobile computing device of claim 28, wherein:
means for analyzing before runtime the anticipated behaviors to generate the static analysis results comprises means for classifying one or more of the anticipated behaviors as benign; and
means for controlling operations of the behavior-based analysis system based on the static analysis results comprises:
means for forgoing analysis of an activity that corresponds to an anticipated behavior classified as benign; or
means for selecting for analysis by the behavior-based analysis system only activities that correspond to the anticipated behaviors classified as suspicious.

30. The mobile computing device of claim 28, wherein:
means for analyzing before runtime the anticipated behaviors to generate the static analysis results comprises means for generating a first behavior vector that includes static behavior information;
means for analyzing activities of the software application during runtime via the behavior-based analysis system comprises means for generating a second behavior vector that includes dynamic behavior information; and
means for controlling operations of the behavior-based analysis system based on the static analysis results comprises means for combining the first behavior vector and the second behavior vector to generate a third behavior vector that includes both static behavior information and dynamic behavior information.
